(19) United States
(12) Patent Application Publication
(10) Pub. No.: US 2006/0203929 A1
(43) Pub. Date: Sep. 14, 2006

(54) Apparatus and method of detecting a sync signal and a VSB receiver using the same

(76) Inventors: Jung-won Kwak, Seoul (KR); Dong-hoon Lee, Suwon-si (KR)

Correspondence Address: STANZIONE & KIM, LLP, 919 18TH STREET, N.W., SUITE 440, WASHINGTON, DC, 20006, US

(21) Appl. No.: 11/300,340

(22) Filed: Dec. 15, 2005

(30) Foreign Application Priority Data
Mar. 11, 2005 (KR) 2005-20557

(51) Int. Cl. H04L 27/02; H04L 27/06

(52) U.S. Cl. 375/270; 375/343

(57) ABSTRACT

A sync signal detecting apparatus, a method thereof, and a Vestigial Side Band receiver employing the apparatus. The apparatus includes a correlator to compute one or more correlation values of the received signal, a starting point determiner to detect a location of a received signal having a maximum correlation value within an arbitrary period, and to determine a location a predetermined interval from the detected location as a starting point, a main signal detector to determine a signal having a value obtained by multiplying one of the correlation values by a predetermined number that is larger than the maximum correlation value as a main signal among signals during the arbitrary period, and a location detector to detect and provide a location of the main signal to the equalizer. Accordingly, performance of an equalizer can be maximized by determining the main signal variably according to characteristics of the equalizer.

### CROSS-REFERENCE TO RELATED APPLICATIONS

This application claims the benefit under 35 U.S.C. § 119 (a) of Korean Patent Application No. 2005-20557 filed on Mar. 11, 2005 in the Korean Intellectual Property Office, the disclosure of which is incorporated herein by reference in its entirety.

### BACKGROUND OF THE INVENTION

1. Field of the Invention

The present general inventive concept relates to an apparatus to detect a sync signal, a method thereof, and a Vestigial Side Band (VSB) receiver employing the same, and more particularly, to a sync signal detecting apparatus that selects a main signal variably according to a performance of an equalizer instead of selecting a maximum correlation value as the main signal, a method thereof, and a VSB receiver employing the sync signal detecting apparatus.

2. Description of the Related Art

In a receiver that receives data transmitted in a Vestigial Side Band (VSB) modulation scheme, a frequency offset and phase noise caused by a tuner or a radio frequency (RF) oscillator during data reception should be minimized for data demodulation. This process is called “carrier recovery.” A digital broadcasting system employing a VSB modulation scheme of the Advanced Television System Committee (ATSC), which sets standards for American digital television, uses a pilot signal existing in a transmitting signal for carrier synchronization. The pilot signal is carried on a carrier during data transmission to be used for precisely recovering the carrier.

A process of generating a clock signal in a receiver, which is the same as a clock signal that is used in a transmitter, in order to receive precise data is called “symbol timing recovery.”

FIG. 1A is a block diagram illustrating a conventional sync signal detector in a VSB receiver, and FIG. 1B is a diagram illustrating a relationship between a period of a counter 70 and a correlation value in the conventional sync signal detector of FIG. 1A.

Referring to FIG. 1A, the conventional sync signal detector includes a correlator 10, a maximum value detector 30, a location detector 50, and the counter 70.

The correlator 10 computes correlation values between a received signal and a reference signal. Herein, a field sync signal or a segment sync signal can be the reference signal. The correlation value can be obtained by computing a correlation value between In-phase (I) signals of the received signal and the reference signal, or by computing a first correlation value between I signals of the received signal and the reference signal and a second correlation value between Quadrature-phase (Q) signals of the received signal and the reference signal.

The maximum value detector 30 detects the largest value among the correlation values computed in the correlator 10.

The location detector 50 detects a location where the largest correlation value is obtained as a starting point where valid data exists in the received signal.

The counter 70 counts a number of symbols based on an arbitrary field period so that the location detector 50 can detect a location where the maximum correlation value is obtained in the arbitrary field period. The counter 70 determines whether the location where the maximum correlation value is obtained in the location detector 50 corresponds to the same index.

Referring to FIG. 1B, a main signal having the maximum correlation value during a period t1 of the counter 70 is detected to be a signal A. Thus, in an equalizer receiving information about the location where the maximum correlation value is obtained from the conventional sync signal detector, a signal B is a pre-echo of the signal A. However, since an index of a signal B′ is larger than an index of the signal A in the period t1, the signal B′ becomes a post-echo of the signal A.

When the correlation values are detected as illustrated in FIG. 1B and the equalizer exhibits an excellent performance in removing the post-echo, equalization performance of the equalizer can be maximized by determining the signal B as the main signal, instead of the signal A. On the other hand, if the equalizer exhibits an excellent performance in removing the pre-echo, the performance of the equalizer can be maximized by determining a signal having a larger index than the signal having the maximum correlation value and a correlation value similar to the maximum correlation value as the main signal.

Also, when the signal A and the signal B have similar correlation values, and the signal A is larger than the signal B or the signal B is larger than the signal A, there is a problem in that an amount of time for obtaining synchronization is increased, because a location of the main signal having the maximum correlation value is changed or the determination on the main signal is delayed.

### SUMMARY OF THE INVENTION

The present general inventive concept provides a sync signal detecting apparatus that can maximize performance of an equalizer by changing a time in which to detect a location where a maximum correlation value is obtained and varying a main signal according to the performance of the equalizer, a method thereof, and a Vestigial Side Band (VSB) receiver employing the sync signal detecting apparatus.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a sync signal detecting apparatus usable with a VSB receiver having an equalizer to remove multipath of received signals caused by a channel environment based on a detected sync signal, the sync signal detecting apparatus including a correlator to compute one or more correlation values of the received signal, a starting point determiner to detect a location of the received signal having a maximum correlation value within an arbitrary period based on the computed correlation values and to determine a location a predetermined interval from the detected location as a starting point of a period in which to detect a sync signal, a main signal detector to determine a signal having a value obtained by multiplying one of the correlation values by a predetermined number that is larger than the maximum correlation value of the sync signal detecting period as a main signal among signals during the sync signal detecting period from the determined starting point based on equalization performance of the equalizer, and a location detector to detect a location of the main signal and to provide the detected location of the determined main signal as location information of the sync signal to the equalizer.

The main signal detector may include a comparator to compute one or more second correlation values of one or more second received signals sequentially from the determined starting point of the sync signal detecting period and to compare the computed second correlation values with the maximum correlation value determined from among the computed correlation values of the received signals computed prior to the computation of the second correlation values, and a main signal determiner to determine a value obtained by multiplying the computed second correlation value by a predetermined number as a second maximum correlation value when the second computed correlation value is larger than the maximum correlation value and to determine a second signal having the determined second maximum correlation value as the main signal when the sync signal detecting period ends.

When the second computed correlation value is smaller than the maximum correlation value and the sync signal detecting period has not ended, the main signal detector determines the signal having the maximum correlation value as the main signal.

When the sync signal detecting period has not ended, the main signal detector computes a correlation value of a received signal after the second signal having the second determined maximum correlation value, compares the correlation value of the after received signal with the determined second maximum correlation value, and determines the main signal according to the comparison result.

The predetermined number may be smaller than 1 when the equalizer has an excellent performance in removing pre-echo, and the predetermined number may be larger than 1 when the equalizer has an excellent performance in removing post-echo.

When the equalizer has an excellent performance in removing pre-echo, the main signal detector detects a signal after the maximum correlation value as the main signal, and when the equalizer has an excellent performance in removing post-echo, the main signal detector detects a signal before the maximum correlation value as the main signal.

The predetermined interval may be a half field.

The foregoing and/or other aspects of the present general inventive concept may also be achieved by providing a sync signal detecting apparatus to provide sync signal location information to an equalizer, comprising a sync signal location determiner to calculate a plurality of correlation values between a plurality of signal portions of a received signal in a period and a reference signal, to determine a signal portion having a maximum correlation value among the plurality of calculated correlation values, to determine a signal portion that is temporally adjacent to the signal portion having the maximum correlation value as a sync signal in the period according to equalizer performance settings, and to output location information thereof to the equalizer.

The foregoing and/or other aspects of the present general inventive concept may also be achieved by providing an apparatus to determine a sync signal for an equalizer, comprising a starting point determiner to receive a signal having a plurality of signal portions having corresponding correlation values and to determine a main signal detecting period such that a signal portion having a maximum correlation value and an echo signal portion are adjacent to each other in the same main signal detecting period, and a main signal detector to scale one of a correlation value of the echo signal portion and the maximum correlation value such that a comparator selects the echo signal portion as a main signal of the main signal detecting period.

The foregoing and/or other aspects of the present general inventive concept may also be achieved by providing a VSB receiver including a down-converter to convert received signals input through an antenna into baseband signals, a sync signal detector to determine a location a predetermined interval from a location of one of the received signals having a maximum correlation value within an arbitrary period among correlation values of the receiving signals as a starting point of a period in which to detect a sync signal, to detect a signal having a value obtained by multiplying the correlation value by a predetermined number according to equalization performance of an equalizer as a main signal among signals occurring during the sync signal detecting period, and to detect the main signal as a sync signal, a carrier recovery unit to compensate for frequency by using a frequency offset estimated based on the received signal and the detected sync signal, a symbol timing recovery unit to detect the starting point and an end point of a symbol of the received signal based on the received signal and the detected sync signal, the equalizer to remove multipath of the received signal caused by a channel environment based on the detected sync signal, and a decoder to perform error correction and decoding on the received signal according to the error correction and encoding method applied to the received signal.

The foregoing and/or other aspects of the present general inventive concept may also be achieved by providing a Vestigial Side Band (VSB) receiver, comprising a sync signal location determiner to calculate a plurality of correlation values between a plurality of signal portions of a received signal in a period and a reference signal, to determine a signal portion having a maximum correlation value among the plurality of calculated correlation values, to determine a signal portion that is temporally adjacent to the signal portion having the maximum correlation value as a sync signal in the period, and to output location information thereof according to performance settings of the equalizer, and an equalizer to remove multipath interference of the received signal according to the output location information of the sync signal.

The foregoing and/or other aspects of the present general inventive concept may also be achieved by providing a sync signal detecting method usable in a VSB receiver having an equalizer to remove multipath of received signals caused by a channel environment based on a detected sync signal, the method including computing one or more correlation values of the received signals, detecting a location of one of the received signals having a maximum correlation value within an arbitrary period based on the corresponding computed correlation value, and determining a location a predetermined interval from the detected location as the starting point of a period in which to detect a sync signal, detecting a signal having a value obtained by multiplying one of the correlation values by a predetermined number that is larger than the maximum correlation value of the sync signal detecting period as a main signal among signals during the sync signal detecting period from the determined starting point based on equalization performance of the equalizer, and detecting a location of the main signal and providing the location of the detected main signal as location information of the sync signal to the equalizer.

The detecting of the signal having the value obtained by multiplying the correlation value by the predetermined number comprises computing one or more second correlation values of second received signals sequentially from the determined starting point and comparing one of the computed second correlation values with the maximum correlation value determined from among the correlation values of the received signals computed prior to the computation of the second correlation values, and determining a value obtained by multiplying the second computed correlation value by the predetermined number as a second maximum correlation value when the computed second correlation value is larger than the maximum correlation value, and determining a signal having the second determined maximum correlation value as the main signal when the sync signal detecting period ends.

When the second computed correlation value is smaller than the maximum correlation value and the sync signal detecting period ends, the signal having the maximum correlation value is determined as the main signal.

When the sync signal detecting period has not ended, a correlation value of a received signal after the second signal having the second determined maximum correlation value is computed and compared with the second determined maximum correlation value, and the main signal is determined according to the comparison result.

The predetermined number may be smaller than 1 when the equalizer has an excellent performance in removing pre-echo, and the predetermined number may be larger than 1 when the equalizer has an excellent performance In removing post-echo.

When the equalizer has an excellent performance in removing pre-echo, a signal after the maximum correlation value is detected as the main signal, and when the equalizer has an excellent performance in removing post-echo, a signal before the maximum correlation value is detected as the main signal.

The predetermined interval may be a half field.

The foregoing and/or other aspects of the present general inventive concept may also be achieved by providing a method of detecting a sync signal to provide sync signal location information to an equalizer, the method comprising calculating a plurality of correlation values between a plurality of signal portions of a received signal in a period and a reference signal, determining a signal portion having a maximum correlation value among the plurality of calculated correlation values, and determining a signal portion that is temporally adjacent to the signal portion having the maximum correlation value as a sync signal in the period according to equalizer performance settings, and outputting location information thereof to the equalizer.

The foregoing and/or other aspects of the present general inventive concept may also be achieved by providing a method of determining a sync signal for an equalizer, the method comprising receiving a signal having a plurality of signal portions having corresponding correlation values, determining a main signal detecting period such that a signal portion having a maximum correlation value and an echo signal portion are adjacent to each other in the same main signal detecting period, and scaling one of a correlation value of the echo signal portion and the maximum correlation value such that a comparator selects the echo signal portion as a main signal of the main signal detecting period.

The foregoing and/or other aspects of the present general inventive concept may also be achieved by providing a method of determining a sync signal location to provide to an equalizer, the method comprising determining a location of an echo signal portion of a signal portion having maximum correlation value in a period, and outputting the location of the echo signal portion as the sync signal location to the equalizer.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIGS. 1A and 1B are diagrams illustrating a conventional sync signal detector in a Vestigial Side Band (VSB) receiver and an operation of the conventional sync signal detector;

FIG. 2 is a block diagram illustrating a VSB receiver in accordance with an embodiment of the present general inventive concept;

FIG. 3 is a block diagram illustrating a sync signal detector of the VSB receiver of FIG. 2;

FIGS. 4A and 4B are flowcharts illustrating a sync signal detecting method in accordance with an embodiment of the present general inventive concept; and

FIG. 5 is a timing diagram illustrating a relationship between a period and a correlation to detect a maximum correlation value in accordance with an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

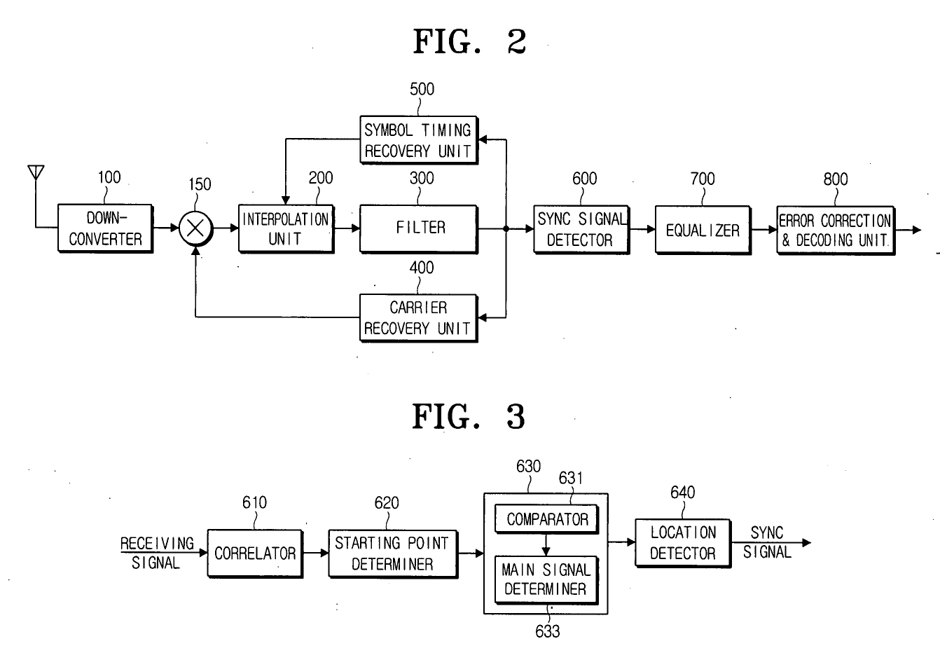

FIG. 2 is a block diagram illustrating a Vestigial Side Band (VSB) receiver in accordance with an embodiment of the present general inventive concept.

Referring to FIG. 2, the VSB receiver includes a down converter 100, a mixer 150, an interpolation unit 200, a filter 300, a carrier recovery unit 400, a symbol timing recovery unit 500, a sync signal detector 600, an equalizer 700, and an error correction and decoding unit 800.

The down converter 100 converts radio frequency (RF) signals received through an antenna into intermediate frequency (IF) signals and converts the IF signals into baseband signals to lower a frequency thereof.

The mixer 150 corrects the frequency of the received baseband signals by using a frequency offset detected in the carrier recovery unit 400.

The interpolation unit 200 precisely recovers symbol timing of the received signals by using a symbol timing offset detected in the symbol timing recovery unit 500.

The filter 300 extracts a desired signal from among output signals of the interpolation unit 200. Herein, the filter may be a matched filter.

The carrier recovery unit 400 compensates for frequency based on the frequency offset estimated by using a pilot tone of the received signals.

The symbol timing recovery unit 500 determines a moment when each symbol begins and a moment when each symbol ends based on a sync signal and data signals of the received signals.

The sync signal detector 600 detects a maximum correlation value based on a training sequence and correlation values of the received signals, and generates data frame indicator signals from a location where the maximum correlation value is obtained. The location where the maximum correlation value occurs corresponds to a location of the training sequence. The sync signal detector 600 then provides information about the location of the training sequence to the equalizer 700.

Herein, the sync signal detector 600 determines a signal having a smaller correlation value than the maximum correlation value as a main signal according to a performance of the equalizer 700. The equalizer 700 may have an excellent performance in removing pre-echo or post-echo. If the equalizer 700 can remove pre-echo effectively, the equalization performance of the equalizer 700 can be maximized by determining a signal in a location having a larger index than a location of the maximum correlation value as the main signal. An index refers to a relative location of a signal within a period.

On the other hand, if the equalizer 700 can remove post-echo effectively, the equalization performance of the equalizer 700 can be maximized by determining a signal in a location having a smaller index than the location of the maximum correlation as the main signal.

In order to determine whether the main signal, which is varied in order to maximize the performance of the equalizer 700, corresponds to the pre-echo or post-echo of the signal having the maximum correlation value, a time to detect the signal having the maximum correlation value is moved. In other words, a main signal detecting period is shifted. Then, a signal having a similar correlation value to the maximum correlation value that is before or after the signal having the maximum correlation value (i.e., a pre-echo signal or a post-echo signal, respectively) is determined as the main signal depending on the performance of the equalizer 700.

The equalizer 700 removes multi-path of the received signals caused by a channel environment based on the main signal determined in the sync signal detector 600.

The error correction and decoding unit 800 performs error correction and decoding on the received signals according to the error correction and encoding method used by a transmitting system.

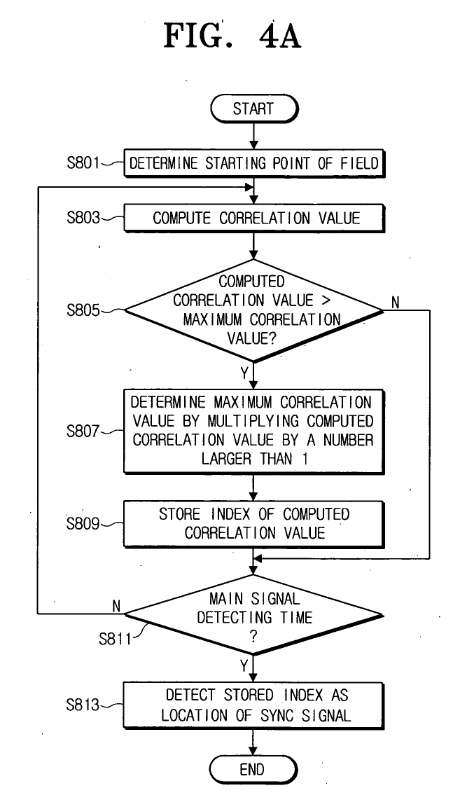

FIG. 3 is a block diagram illustrating the sync signal detector 600 of FIG. 2.

Referring to FIG. 3, the sync signal detector 600 includes a correlator 610, a starting point determiner 620, a main signal detector 630, and a location detector 640. The main signal detector 630 includes a comparator 631 and a main signal determiner 633.

The correlator 610 computes a correlation value between a received signal and a reference signal. The correlator 610 may compute one or more correlation values of a plurality of portions of the received signal. Herein, a field sync signal, a segment sync signal, or a pseudo noise signal can be used as the reference signal. The correlation value can be obtained by calculating the correlation value between In-phase (I) signals of the reference signal and the received signal. Alternatively, the correlation value can be obtained by computing a first square value of the correlation value between the I signals of the reference signal and the received signal and a second square value of the correlation value between Quadrature-phase (Q) signals of the reference signal and the received signal and adding the first and second square values.

The starting point determiner 620 determines a starting point of a period in which to detect a signal having the maximum correlation value (i.e., the main signal detecting period). The starting point is a location moved by a half field from a location of the signal having the maximum correlation value which is detected based on an arbitrary field period of a counter (not shown). Thus, the main signal detector 630 should be able to detect the main signal during the arbitrary field period from the determined starting point, and the main signal detector 630 should be able to identify whether a signal is a pre-echo and/or a post-echo based on the signal having the maximum correlation value.

The main signal detector 630 includes the comparator 631 and the main signal determiner 633, and the main signal detector 630 determines the main signal during the arbitrary field period from the determined starting point. After detecting the signal having the maximum correlation value, the main signal detector 630 determines a signal located before or after the signal having the maximum correlation value as the main signal based on the performance of the equalizer 700.

More specifically, the comparator 631 compares the correlation values of the received signals (i.e., the plurality of portions of the received signal) which are computed sequentially from the starting point of the main signal detecting period, which is obtained in the starting point determiner 620, with the maximum correlation value of the main signal detecting period. The maximum correlation value can be determined/stored and re-determined/stored a number of times as the comparator 631 moves through the main signal detecting period.

When the correlation value of a second received signal (e.g., a current received signal) is larger than the maximum correlation value, the main signal determiner 633 multiplies the correlation value of the current received signal by a predetermined number so that the signal located before or after the second received signal having the maximum correlation value (i.e., the current received signal) is determined as the main signal. If the predetermined number by which the correlation value of the received signal is multiplied is smaller than 1, a signal located after the received signal having the maximum correlation value (i.e., a signal corresponding to post-echo) is determined as the main signal. Since the signal corresponding to the post-echo is determined as the main signal, the equalizer 700 will be able to have excellent performance in removing a plurality of pre-echoes that come before the main signal.

On the other hand, if the predetermined number by which the correlation value of the received signal is multiplied is larger than 1, a signal located before the received signal having the maximum correlation value (i.e., a signal corresponding to pre-echo) is determined as the main signal. Since the signal corresponding to the pre-echo is determined as the main signal, the equalizer 700 will be able to have an excellent performance in removing a plurality of post-echoes that come after the main signal. When the signal that corresponds to the pre-echo (of the signal having an actual maximum correlation value within the main signal detecting period) is to be selected as the main signal, a correlation value of the signal that corresponds to the pre-echo is multiplied by the predetermined number that is greater than 1 in order to increase the likelihood that the multiplied correlation value of the signal that corresponds to the pre-echo will be greater than the actual maximum correlation value within the main signal detecting period. Similarly, when the signal that corresponds to the post-echo (of the signal having an actual maximum correlation value within the main signal detecting period) is to be selected as the main signal, the actual maximum correlation value is multiplied by the predetermined number that is less than 1 in order to increase the likelihood that the multiplied maximum correlation value will be less than the correlation value of the signal that corresponds to the post-echo within the main signal detecting period.

The location detector 640 detects the location of the main signal detected in the main signal detector 630, determines the location of the main signal as the location of a sync signal, and provides information about the location of the sync signal to the equalizer 700.

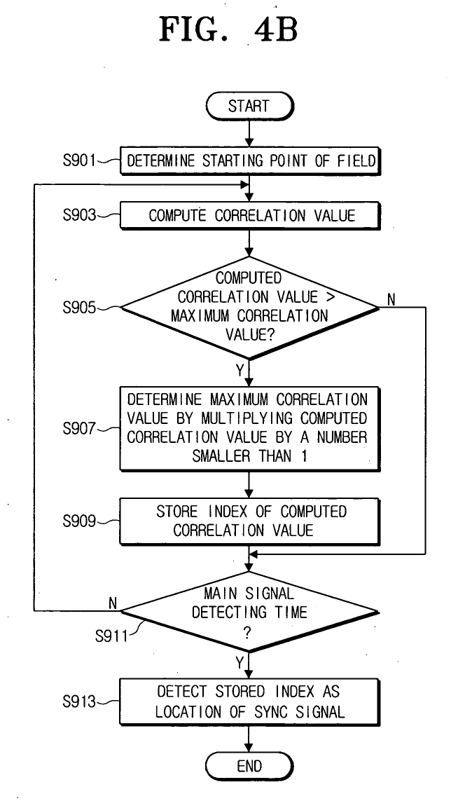

FIGS. 4A and 4B are flowcharts illustrating a sync signal detecting method in accordance with an embodiment of the present general inventive concept. FIG. 4A is a flowchart illustrating a sync signal detecting method used when the equalizer 700 has an excellent performance in removing the post-echo, and FIG. 4B is a flowchart illustrating a sync signal detecting method used when the equalizer 700 has an excellent performance in removing the pre-echo. The methods of FIGS. 4A and 4B may be performed by the main signal detector of FIG. 3. Accordingly, the methods of FIGS. 4A and 4B are described below with reference to FIGS. 2 and 3.

Referring to FIG. 4A, at operation S801, the starting point of a period in which to detect the signal having the maximum correlation value (i.e., the main signal detecting period) is determined by using the correlation values computed between the received signal and the reference signal. The starting point is determined to be a location shifted by a predetermined interval from the location of the received signal having the maximum correlation value, which is detected based on the arbitrary field period. Thus, the main signal should be detectable during the arbitrary field period from the determined starting point, and the pre-echo and-the post-echo should be identified based on the received signal detected as having the maximum correlation value. Herein, the predetermined interval between the location of the received signal having the maximum correlation value and the starting point may be a half field.

At operation S803, the correlation values between the received signals and the reference signal are computed sequentially from the determined starting point.

At operation S805, the computed correlation values are compared with the maximum correlation value determined from among the correlation values of the received signals, before the computation of the correlation value. In other words, a current correlation value (i.e., a second correlation value) is compared with the maximum correlation value determined from among previous correlation values that are computed, before the current correlation value is computed. The correlation values, which are targets to be compared, are compared with the maximum correlation value determined among the correlation values (i.e., the previous correlation values) of the received signals, before the computation of the correlation value (i.e., the current correlation value), which are the targets to be compared, within the main signal detecting period. The maximum correlation value can be determined and re-determined a number of times at the operation S805.

Subsequently, at operation S807, when the computed correlation value (i.e., the current correlation value) is larger than the maximum correlation value determined from among the previous correlation values of the received signals determined before the computation of the current correlation value (i.e., the second correlation value), a value obtained by multiplying the current computed correlation value by a number larger than 1 is determined as the maximum correlation value within the main signal detecting period. Accordingly, a signal that corresponds to the pre-echo is determined as the main signal when the equalizer 700 is excellent in removing the post-echo. In other words, when the current computed correlation value is larger than the maximum correlation value within the main signal detecting period, the correlation value obtained by multiplying the current computed correlation value by the number larger than 1 is increased and a signal having the increased correlation value is determined as the main signal. Herein, it is possible to control a percentage of the correlation value that a signal has to be determined as the main signal by controlling the number by which the computed correlation value is multiplied.

Subsequently, at operation S809, the location of the signal having the computed correlation value, which is an index of the computed correlation value, is stored. Accordingly, it is determined that the location of the stored index is the location of a sync signal, when the signal having the stored index is finally determined as the main signal.

At operation S811, it is determined whether the main signal detecting period (time), which extends from the determined starting point to a period termination time, has ended. If the main signal detecting period has not ended, the operations (i.e., operations S803, S805, etc.) after the operation S801 are then repeated. Therefore, the correlation values of received signals after the signal having the stored index are computed, and the computed correlation values are compared with the correlation value of the signal having the stored index to determine the maximum correlation value and to store the index of the signal having the maximum correlation value.

Once the main signal detecting period (time) has ended, there is no signal for which to determine the maximum correlation value by computing the correlation value. Thus, at operation S813, the stored index, which corresponds to the main signal, is determined as the location of the sync signal. Herein, information about the location of the determined sync signal is provided to the equalizer 700.

When the current correlation value computed at the operation S803 is smaller than the maximum correlation value determined from among the previous correlation values of the received signals before the computation of the current correlation value, the operations beginning with the operation S811 are repeated. Therefore, when the main signal detecting period (time) is determined to have ended at the operation S811, the current computed correlation value is not stored as the index having the maximum correlation value. In this case, a signal having an index that is previously stored (i.e., stored prior to the computation of the current correlation value) as having the maximum correlation value determined from among the correlation values (i.e., the previous correlation values) of the received signals before the computation of the correlation value (i.e., the current correlation value) is determined as the sync signal. Otherwise, when the main signal detecting period (time) is determined not to have ended, the operations beginning with the operation S803 are repeated.

FIG. 4B is a flowchart illustrating a sync signal detecting method when the equalizer 700 has an excellent performance in the removal of the pre-echo. More specifically, FIG. 4B illustrates a method of determining a signal that corresponds to the post-echo located after the signal having the maximum correlation value as the main signal.

Referring to FIG. 4B, the main signal is determined in a similar manner as described with reference to FIG. 4A. In particular, operations S901, S903, S905, S909, S911, and S913 are similar to operations S801, S803, S805, S809, S811, and S813 in FIG. 4A, and a description thereof will not be provided. When the correlation value (i.e., the current correlation value) computed at the operation S903 is determined to be larger than the maximum correlation value at the operation S905, a value obtained by multiplying the computed correlation value by a number smaller than 1 is determined as the maximum correlation value within the main signal detecting period (time). Accordingly, a signal that corresponds to the post-echo is determined as the main signal when the equalizer 700 has an excellent performance in the removal of the pre-echo. In other words, when the computed correlation value (i.e., the current correlation value) is larger than the maximum correlation value determined from among the previous correlation values within the main signal detecting period (time), the current computed correlation value is decreased by multiplying the current computed correlation value by a number that is smaller than 1 to determine a signal after the signal having the reduced correlation value as the main signal. Although the correlation values within the main signal detecting period are referred to as current (i.e., second) correlation values and previous correlation values, it should be understood that this relationship is not intended to limit the scope of the present general inventive concept. The terms “current” and “previous” are used for illustration purposes only to describe how the comparator 631 processes the correlation values of the received signals from a beginning to an end of the main signal detecting period.

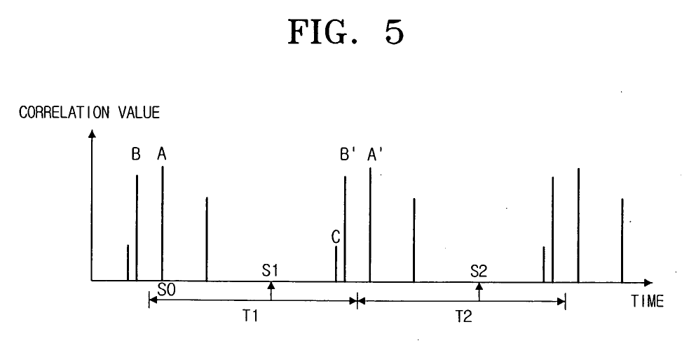

FIG. 5 is a timing diagram illustrating a relationship between the main signal detecting period and a correlation to detect the maximum correlation value. Herein, the horizontal axis represents time while the vertical axis represents correlation values. T1 and T2 represent preset periods in which to detect the main signal, individually, and they correspond to the arbitrary field periods applied to the counter. S0 is a location of a signal A detected as the maximum correlation value in the period T1, and S1 is a location that is shifted a half field away from the location S0. S2 represents a location where the main signal detecting period ends when the location S1 is determined as the starting point of the main signal detecting period. The period between the locations S1 and S2 corresponds to the main signal detecting period.

FIG. 5 illustrates a method of determining a signal B′ as the main signal, instead of the signal A which has the maximum correlation value (i.e., an actual maximum correlation value within the main signal detecting period), when the equalizer 700 has an excellent performance in the removal of the post-echo. When the location S1 is determined as the starting point of the main signal detecting period and the main signal is detected within the main signal detecting period between the locations S1 and S2, correlation values are computed sequentially beginning at the location S1.

First, the correlation value of a signal C is computed and compared with the maximum correlation value within the main signal detecting period. Since the signal C is the first signal of the main signal detecting period, the correlation value of the signal C is compared with a default correlation value, and a value obtained by multiplying the correlation value of the signal C by a predetermined number that is larger than 1 is determined (i.e., set) as the maximum correlation value. An index of the signal C is then stored to correspond to the maximum correlation value.

The correlation value of the signal B′ is then computed, and the product of the correlation value of the signal C and the predetermined number that is larger than 1, which is the set maximum correlation value of the period, is compared with the correlation value of the signal B′. When the correlation value of the signal B′ is larger than the set maximum correlation value, a value obtained by multiplying the correlation value of the signal B′ by the predetermined number larger than 1 is determined as the maximum correlation value (i.e., an updated maximum correlation value) and the index of the signal B′ is stored. In other words, the maximum correlation value is re-determined (updated),to occur at a location of the signal B′.

The correlation value of the signal A′ is then computed and the product of the correlation value of the signal B′ and the predetermined number that is larger than 1, which is the set maximum correlation value, is compared with the correlation value of the signal A′. When the product of the correlation value of the signal B′ and the predetermined number larger than 1 (i.e., the set maximum correlation value) is larger than the correlation value of the signal A′, the stored signal B′ is determined as the main signal.

The signal actually having the maximum correlation value during the main signal detecting period between the locations S1 and S2 is the signal A′. When the signal A′ is determined as the main signal, the equalizer 700 (see FIG. 2) determines a signal after the signal A′ as the post-echo and removes the signal after the signal A′. However, when the equalizer 700 exhibits excellent performance in removing the post-echo, the equalizer 700 determines the signal B′ as the main signal and determines a signal after the signal B′ as the post-echo, thereby enhancing the equalization performance. That is, the equalizer 700 determines the signal A′ as the post echo and removes the signal A′ during equalization when the equalizer 700 has excellent performance in removing the post echo.

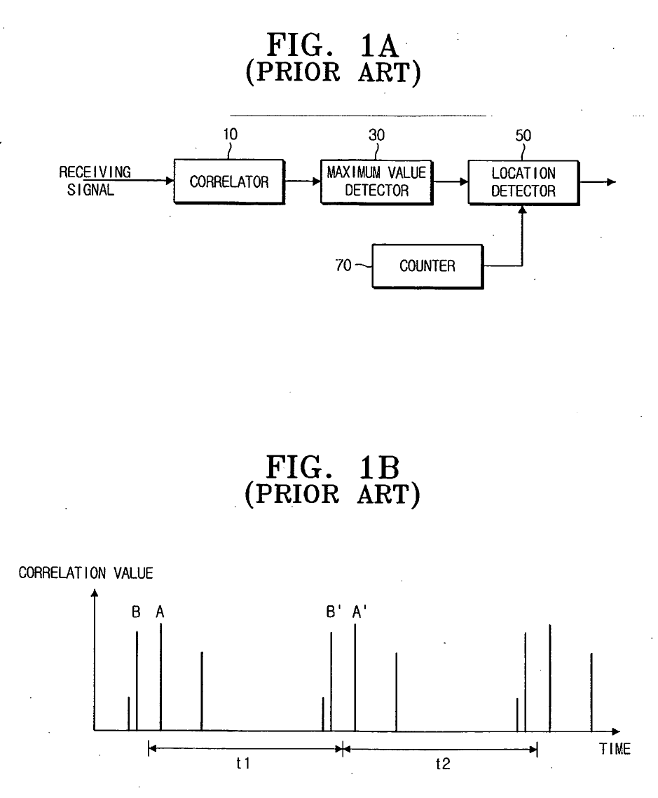

Also, as opposed to the conventional sync signal detector (see FIG. 1) where it is difficult to determine whether the signal B′ is the pre-echo located before the signal A′ or the post-echo located after the signal A, the equalizer 700 can determine that the signal B′ is the pre-echo located before the signal A′ by determining the location S1 as the starting point of the main signal detecting period.

As described above, the various embodiments of the present general inventive concept can improve performance of an equalizer by providing location information of pre-echo and post-echo detected in a sync signal detecting apparatus to the equalizer.

Accordingly, performance of an equalizer can be maximized by determining a main signal variably according to characteristics of the equalizer, and a cost of hardware and time can be reduced by storing a channel profile in advance and by determining a location of the main signal that can maximize the performance of the equalizer once correlation values within a main signal detecting period are all read.

In addition, the various embodiments of the present general inventive concept can prevent problems in that an amount of time to determine a main signal is delayed when signals having similar correlation values are detected as a signal having the maximum correlation value alternately, and that a location detected as a location of the main signal is changed according to time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A sync signal detecting apparatus usable with a Vestigial Side Band (VSB) receiver having an equalizer to remove multipath of received signals caused by a channel environment based on a detected sync signal, the apparatus comprising:
a correlator to compute one or more correlation values of a received signal;
a starting point determiner to detect a location of the received signal having a maximum correlation value within an arbitrary period based on the computed correlation values and to determine a location a predetermined interval from the detected location as a starting point of a period in which to detect a sync signal;
a main signal detector to determine a signal having a value obtained by multiplying one of the correlation values by a predetermined number that is larger than the maximum correlation value of the sync signal detecting period as a main signal among signals during the sync signal detecting period from the determined starting point based on equalization performance of the equalizer; and
a location detector to detect a location of the main signal and to provide the detected location of the determined main signal as location information of the sync signal to the equalizer.

2. The apparatus as recited in claim 1, wherein the main signal detector comprises:
a comparator to compute one or more second correlation values of one or more received signals sequentially from the determined starting point of the sync signal detecting period and to compare the computed second correlation values with the maximum correlation value determined from among the computed correlation values of the received signals computed prior to the computation of the second correlation values; and
a main signal determiner to determine a value obtained by multiplying the computed second correlation values by the predetermined number as a second maximum correlation value when the second computed correlation value is larger than the maximum correlation value, and when the sync signal detecting period has ended, to determine a second signal having the determined second maximum correlation value as the main signal.

3. The apparatus as recited in claim 2, wherein when the computed second correlation value is smaller than the maximum correlation value and the sync signal detecting period has ended, the main signal detector determines the signal having the maximum correlation value as the main signal.

4. The apparatus as recited in claim 2, wherein when the sync signal detecting period has not ended, the main signal detector computes a correlation value of a received signal that comes after the second signal having the determined second maximum correlation value, compares the correlation value of the after signal with the determined second maximum correlation value, and determines the main signal according to the comparison result.

5. The apparatus as recited in claim 1, wherein the predetermined number is smaller than 1 when the equalizer has an excellent performance in removing pre-echo, and the predetermined number is larger than 1 when the equalizer has an excellent performance in removing post-echo.

6. The apparatus as recited in claim 1, wherein when the equalizer has an excellent performance in removing pre-echo, the main signal detector detects a signal after the maximum correlation value as the main signal, and when the equalizer has an excellent performance in removing post-echo, the main signal detector detects a signal before the maximum correlation value as the main signal.

7. The apparatus as recited in claim 1, wherein the predetermined interval is a half field.

8. A sync signal detecting apparatus to provide sync signal location information to an equalizer, comprising:
a sync signal location determiner to calculate a plurality of correlation values between a plurality of signal portions of a received signal in a period and a reference signal, to determine a signal portion having a maximum correlation value among the plurality of calculated correlation values, to determine a signal portion that is temporally adjacent to the signal portion having the maximum correlation value as a sync signal in the period according to equalizer performance settings, and to output location information thereof to the equalizer.

9. The sync signal detecting apparatus as recited in claim 8, wherein the sync signal location determiner comprises:
a correlator to calculate the plurality of correlation values;
a comparator to receive the plurality of correlation values and to progress through the period by comparing the correlation values of the signal portions to determine the maximum correlation value; and
a location detector to determine a location of the signal portion having the maximum correlation value as a location of the sync signal.

10. The sync signal detecting apparatus as recited in claim 9, wherein the sync signal location determiner further comprises:
a starting point determiner to receive the plurality of correlation values from the correlator, to determine a location of the maximum correlation value, to determine a sync signal detecting period as beginning at a location half of the period away from the location of the maximum correlation value, and to instruct the comparator to begin comparing correlation values at the beginning of the sync signal detecting period.

11. The sync signal detecting apparatus as recited in claim 8, wherein the sync signal location determiner comprises:
a main signal determiner to determine a main signal in the period by selecting the temporally adjacent signal portion to the signal portion having the maximum correlation value and multiplying the correlation value of the temporally adjacent signal portion by a predetermined number according to performance settings of the equalizer.

12. The sync signal detecting apparatus as recited in claim 11, wherein the predetermined number is less than 1, when the performance settings of the equalizer comprise a setting to effectively remove a pre-echo signal portion of the signal portion having the maximum correlation value.

13. The sync signal detecting apparatus as recited in claim 11, wherein the predetermined number is greater than 1, when the performance settings of the equalizer comprise a setting to effectively remove a post-echo signal portion of the signal portion having the maximum correlation value.

14. The sync signal detecting apparatus as recited in claim 8, wherein the temporally adjacent signal portion comprises a signal portion that occurs prior to the signal portion having the maximum correlation value, when the equalizer is set to effectively remove a post-echo signal portion of the signal portion having the maximum correlation value.

15. The sync signal detecting apparatus as recited in claim 8, wherein the temporally adjacent signal portion comprises a signal portion that occurs after the signal portion having the maximum correlation value, when the equalizer is set to effectively remove a pre-echo signal portion of the signal portion having the maximum correlation value.

16. An apparatus to determine a sync signal for an equalizer, comprising:
a starting point determiner to receive a signal having a plurality of signal portions having corresponding correlation values and to determine a main signal detecting period such that a signal portion having a maximum correlation value and an echo signal portion are adjacent to each other in the same main signal detecting period; and
a main signal detector to scale one of a correlation value of the echo signal portion and the maximum correlation value such that a comparator selects the echo signal portion as a main signal of the main signal detecting period.

17. The apparatus as recited in claim 16, wherein:
the main signal detector scales a correlation value of a pre-echo signal portion to increase the correlation value thereof to output the pre-echo signal portion as the main signal, when the equalizer is set to remove a post-echo signal portion; and
the main signal detector scales the maximum correlation value to decrease the correlation value thereof to output the post-echo signal portion as the main signal, when the equalizer is set to remove the pre-echo signal portion.

18. The apparatus as recited in claim 16, further comprising:
a location detector to output a location of the echo signal portion as a location of the sync signal to the equalizer.

19. A Vestigial Side Band (VSB) receiver, comprising:
a down-converter to convert received signals input through an antenna into baseband signals;
a sync signal detector to determine a location a predetermined interval away from the location of one of the received signals having a maximum correlation value within an arbitrary period determined from among correlation values of the received signals as a starting point of a period in which to detect a sync signal, to detect a signal having a value obtained by multiplying the correlation value by a predetermined number according to equalization performance of an equalizer as a main signal among signals occurring during the sync signal detecting period, and to detect the main signal as a sync signal;
a carrier recovery unit to compensate for frequency by using a frequency offset estimated based on the received signal and the detected sync signal;
a symbol timing recovery unit to detect the starting point and an end point of a symbol of the received signal based on the received signal and the detected sync signal;
the equalizer to remove multipath of the received signal caused by a channel environment based on the detected sync signal; and
a decoder to perform error correction and decoding on the received signal according to the error correction and encoding method applied to the received signal.

20. A Vestigial Side Band (VSB) receiver, comprising:
a sync signal location determiner to calculate a plurality of correlation values between a plurality of signal portions of a received signal in a period and a reference signal, to determine a signal portion having a maximum correlation value among the plurality of calculated correlation values, to determine a signal portion that is temporally adjacent to the signal portion having the maximum correlation value as a sync signal in the period according to equalizer performance settings, and to output location information thereof; and
an equalizer to remove multipath interference of the received signal according to the output location information of the sync signal.

21. A sync signal detecting method usable in a Vestigial Side Band (VSB) receiver having an equalizer to remove multipath of received signals caused by a channel environment based on a detected sync signal, the method comprising:
computing one or more correlation values of the received signals;
detecting a location of the received signals having a maximum correlation value within an arbitrary period based on the corresponding computed correlation value, and determining a location a predetermined interval from the detected location as a starting point of a period in which to detect a sync signal;
detecting a signal having a value obtained by multiplying one of the correlation values by a predetermined number that is larger than the maximum correlation value of the sync signal detecting period as a main signal among signals during the sync signal detecting period from the determined starting point based on equalization, performance of the equalizer; and
detecting a location of the main signal and providing the location of the detected main signal, which is location information of the sync signal, to the equalizer.

22. The method as recited in claim 21, wherein the detecting of the signal having the value obtained by multiplying the correlation value by the predetermined number comprises:
computing one or more second correlation values of second received signals sequentially from the determined starting point and comparing one of the computed second correlation values with the maximum correlation value determined from among the correlation values of the received signals computed prior to the computation of the second correlation values; and
determining a value obtained by multiplying the second computed correlation value by the predetermined number as a second maximum correlation value when the second computed correlation value is larger than the maximum correlation value, and determining a signal having the second determined maximum correlation value as the main signal when the sync signal detecting period ends.

23. The method as recited in claim 22, wherein when the computed second correlation value is smaller than the second maximum correlation value and the sync signal detecting period ends, the signal having the second maximum correlation value is determined as the main signal.

24. The method as recited in claim 22, wherein when the sync signal detecting period has not ended, a correlation value of a received signal after the signal having the determined second maximum correlation value is computed and compared with the determined maximum correlation value, and the main signal is determined according to the comparison result.

25. The method as recited in claim 21, wherein the predetermined number is smaller than 1 when the equalizer has an excellent performance in removing pre-echo, and the predetermined number is larger than 1 when the equalizer has an excellent performance in removing post-echo.

26. The method as recited in claim 21, wherein when the equalizer has an excellent performance in removing pre-echo, a signal after the maximum correlation value is detected as the main signal, and when the equalizer has an excellent performance in removing post-echo, a signal before the maximum correlation value is detected as the main signal.

27. The method as recited in claim 21, wherein the predetermined interval is a half field.

28. A method of detecting a sync signal to provide sync signal location information to an equalizer, the method comprising:
calculating a plurality of correlation values between a plurality of signal portions of a received signal in a period and a reference signal;
determining a signal portion having a maximum correlation value among the plurality of calculated correlation values; and
determining a signal portion that is temporally adjacent to the signal portion having the maximum correlation value as a sync signal in the period and to output location information thereof to the equalizer according to equalizer performance settings.

29. The method as recited in claim 28, wherein:
the determining of the signal portion having the maximum correlation value comprises receiving the plurality of correlation values and progressing through the period by comparing the correlation values of the signal portions to determine the maximum correlation value;
the determining of the signal portion that is temporally adjacent to the signal portion having the maximum correlation value as the sync signal comprises determining a location of the signal portion having the maximum correlation value as a location of the sync signal.

30. The method as recited in claim 29, wherein the determining of the signal portion having the maximum correlation value further comprises:
determining a location of the maximum correlation value;
determining a sync signal detecting period as beginning at a location half of the period away from the location of the maximum correlation value; and
beginning the progression through the correlation values at the beginning of the sync signal detecting period.

31. The method as recited in claim 28, wherein the determining of the signal portion that is temporally adjacent to the signal portion having the maximum correlation value as the sync signal comprises:
selecting the temporally adjacent signal portion to the signal portion having the maximum correlation value; and
multiplying the correlation value of the temporally adjacent signal portion by a predetermined number according to performance settings of the equalizer.

32. The method as recited in claim 31, wherein the predetermined number is less than 1, when the performance settings of the equalizer comprise a setting to effectively remove a pre-echo signal portion of the signal portion having the maximum correlation value.

33. The method as recited in claim 31, wherein the predetermined number is greater than 1, when the performance settings of the equalizer comprise a setting to effectively remove a post-echo signal portion of the signal portion having the maximum correlation value.

34. The method as recited in claim 28, wherein the temporally adjacent signal portion comprises a signal portion that occurs prior to the signal portion having the maximum correlation value, when the equalizer is set to effectively remove a post-echo signal portion of the signal portion having the maximum correlation value.

35. The method as recited in claim 28, wherein the temporally adjacent signal portion comprises a signal portion that occurs after the signal portion having the maximum correlation value, when the equalizer is set to effectively remove a pre-echo signal portion of the signal portion having the maximum correlation value.

36. A method of determining a sync signal for an equalizer, the method comprising:
receiving a signal having a plurality of signal portions having corresponding correlation values;
determining a main signal detecting period such that a signal portion having a maximum correlation value and an echo signal portion are adjacent to each other in the same main signal detecting period; and
scaling one of a correlation value of the echo signal portion and the maximum correlation value such that a comparator selects the echo signal portion as a main signal of the main signal detecting period.

37. The method as recited in claim 36, wherein the scaling of one of the correlation value of the echo signal portion and the maximum correlation value comprises:
scaling a correlation value of a pre-echo signal portion to increase the correlation value thereof to output the pre-echo signal portion as the main signal, when the equalizer is set to remove a post-echo signal portion; and
scaling the maximum correlation value to decrease the correlation value thereof to output the post-echo signal portion as the main signal, when the equalizer is set to remove the pre-echo signal portion.

38. The method as recited in claim 36, further comprising:
outputting a location of the echo signal portion as a location of the sync signal to the equalizer.

39. A method of determining a sync signal location to provide to an equalizer, the method comprising:
determining a location of an echo signal portion of a signal portion having maximum correlation value in a period; and
outputting the location of the echo signal portion as the sync signal location to the equalizer.
